(19) United States
(12) Patent Application Publication
(10) Pub. No.: US 2011/0022953 A1
(43) Pub. Date: Jan. 27, 2011

(54) System and method of generating customized dictionary

(75) Inventors: Chaucer Chiu, Taipei (TW); Xiao Yan Xu, Shanghai (CN)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei (TW)

(21) Appl. No.: 12/585,817

(22) Filed: Sep. 25, 2009

(30) Foreign Application Priority Data
Jul. 24, 2009 (TW) 098125116

(51) Int. Cl. G06F 17/20; G06F 17/30

(52) U.S. Cl. 715/259

(57) ABSTRACT

This specification discloses a system of generating a customized dictionary and the method thereof. The system receives dictionary items and the data thereof and generates a dictionary data file according to correlation definitions. It then extracts formats of individual dictionary items. It then generates a format configuration file according to the dictionary items and the formats thereof. Finally, the dictionary data file and the format configuration file are output as a dictionary file. This achieves the goal of generating a customized dictionary according to user's needs.

### BACKGROUND OF THE INVENTION

1. Field of Invention

This invention relates to a dictionary generating system and method. In particular, the invention relates to a system of generating a customized dictionary and the method thereof.

2. Related Art

In recent years, with the popularity of computers, rapid development in network technology and explosion of knowledge and information, the entire world has become a global village so that people have more opportunities to encounter foreign documents. No matter how well a person can master a foreign language, he or she still needs to look up a dictionary from time to time when reading these foreign documents. Most non-native speakers obviously have quite some difficulty in reading such foreign documents. This is why the dictionary is useful here for people to overcome the barrier. However, ordinary dictionaries cannot provide sufficient speed and convenience for people living in the information era. Therefore, dictionary software that can translate a foreign word into user's mother language has been invented.

An electronic dictionary is a digital product that converts a conventional printed dictionary into digital data for faster searching. An ordinary electronic dictionary often has several built-in dictionaries and allows the user to download data via a network. This does not only enable the user to update the data in the electronic dictionary, but also enrich the learning contents. Currently, the development of electronic dictionaries is divided in units of dictionaries. One or some developers are responsible for the research and development (R&D) of a particular dictionary. They need to process and edit the database, interface, index, and search of the dictionary. If a user wants to build up his own dictionary, he can only add existing words into his vocabulary notes as his own dictionary. It is impossible for the user to build his own dictionary with a different format or dictionary items from the original one. This is only possible with the help of the developers. The drawback is that the user has to provide them with the original data file. In this case, there may be security worries. Also, this costs more manpower and resources. Moreover, even if there is a function that allows the user to build his own dictionary, the user can only input simple data such as attribute, explanation, and phonetic symbols. More complicated data such as example sentences, phrases, or comparison cannot be displayed. That is, only data in simple format can be displayed. Therefore, only very few dictionary contents can be displayed when the user is trying to build his own dictionary.

In summary, the prior art always has the problem of being unable to allow the user to build his own dictionary satisfying his personal needs. It is therefore necessary to provide a better solution.

### SUMMARY OF THE INVENTION

In view of the foregoing, the invention discloses a system of generating a customized dictionary and the method thereof.

The disclosed system of generating a customized dictionary includes at least: a receiving module, a setting module, a generating module, an extracting and generating module, and an output module. The receiving module receives at least one dictionary item and the data thereof. Each of the dictionary items corresponds to a correlation definition. The setting module establishes at least one setting sector for each of the dictionary items so as to allow the setting of at least one format for the dictionary item. The generating module generates a dictionary data file for the dictionary items and the corresponding data according to the correlation definitions. The extracting and generating module extracts the formats of individual dictionary items and generates a format configuration file for the dictionary items according to their formats. The output module outputs the dictionary data file and the format configuration file as a dictionary file.

The disclosed method of generating a customized dictionary involves the steps of: receiving at least one dictionary item, each of which has a correlation definition; receiving the data associated with the dictionary items; establishing at least one setting sector for each of the dictionary items for setting at least one format for the dictionary item; generating a dictionary data file for the data of the dictionary items according to the corresponding correlation definitions; extracting the formats of the dictionary items and generating a format configuration file for the dictionary items according to their formats; and outputting the dictionary data file and the format configuration file into a dictionary file.

According to the above description, the disclosed system and method differ from the prior art in that the invention receives the dictionary items and the data thereof and generates the dictionary data file according to the correlation definitions. Afterwards, the invention extracts the formats of individual dictionary items to generate the format configuration file for the dictionary items. Finally, the dictionary data file and the format configuration file are output into a dictionary file. This achieves the goal of generating a customized dictionary according to user's needs.

### BRIEF DESCRIPTION OF THE DRAWINGS

The invention will become more fully understood from the detailed description given herein below illustration only, and thus is not limitative of the present invention, and wherein:

FIG. 1 is a block diagram of the disclosed customized dictionary generating system;

FIG. 2 is a flowchart of the disclosed customized dictionary generating method; and

FIGS. 3 to 5 are schematic views of an embodiment of the disclosed customized dictionary generating system.

### DETAILED DESCRIPTION OF THE INVENTION

The present invention will be apparent from the following detailed description, which proceeds with reference to the accompanying drawings, wherein the same references relate to the same elements.

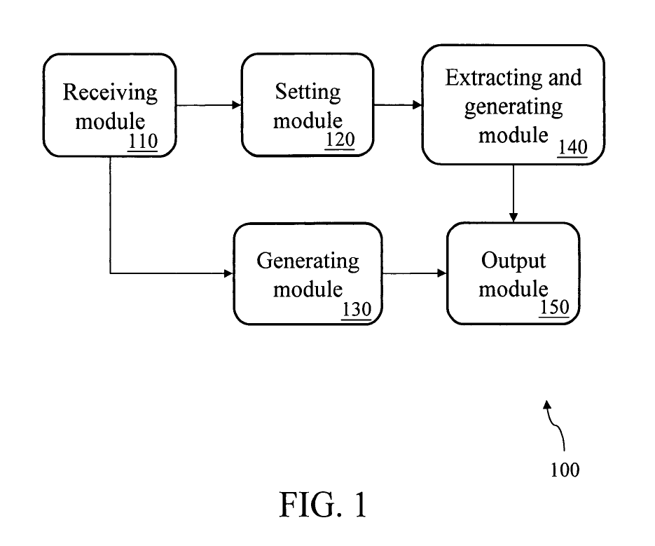

Please refer to FIG. 1, which is a system block diagram of the system of generating a customized dictionary according to the invention. The disclosed system 100 includes at least: a receiving module 110, a setting module 120, a generating module 130, an extracting and generating module 140, and an output module 150. The customized dictionary generating system 100 enables a user to establish a customized dictionary, and the customized dictionary thus generated can be accessed by dictionary software.

The receiving module 110 receives dictionary items and the data thereof. The dictionary items have their corresponding correlation definitions. The dictionary item referred herein is the field to be displayed according to the user. Common dictionary items include “phrase”, “phonetic symbol”, “attribute”, “explanation”, and “example sentence”. If it is a special dictionary, the user can define various kinds of dictionary items as well. For example, the dictionary items in a Buddhism dictionary can include “Sanskrit explanation” and “Tibetan explanation”. In summary, the dictionary items are defined and entered by the user. This can be done with an interface of editing the dictionary items. After the user finishes the input, the receiving module 110 receives the dictionary items as entered by the user.

The dictionary items correspond to correlation definitions. It should be noted that the correlation definition is used to define the data structure of the dictionary items. In the above-mentioned example, the correlation definition for the dictionary item “phrase” is, for example, “first field” and that for the dictionary item “phonetic symbol” is “second field”. However, the invention is not limited by this particular example. Other similar embodiments should be included in the invention as well.

For example, suppose the user enters the dictionary items “phrase”, “explanation”, and “attribute” via the interface of editing dictionary items. The receiving module 110 receives the dictionary items “phrase”, “explanation”, and “attribute” as entered by the user. Moreover, the correlation definition for the dictionary item “phrase” is “first field”, that for the dictionary item “explanation” is “second field”, and that for the dictionary item “attribute” is “third field”.

After the receiving module 110 receives the dictionary items, the user can enter the data of the dictionary items via an interface. It should be noted that the receiving module 110 can receive the data of individual dictionary items using the input fields for the dictionary items or in a batch. That is, after the receiving module 110 receives the dictionary items, the disclosed system 100 establishes an input field for each of the dictionary item, so that the user can enter the data of individual dictionary items. The receiving module 110 then receives the data of these dictionary items.

In the above-mentioned example, the customized dictionary generating system 100 establishes the input fields of “phrase”, “explanation”, and “attribute” for the dictionary items “phrase”, “explanation”, and “attribute”. The user then enters, for example, “server” in the input field of the dictionary item “phrase”, “In a local area network, a data station provides all kinds of facilities to other data stations, such as file server, printer server, and mail server” in the input field of the dictionary item “explanation”, and “computer” in the input field of the dictionary item “attribute”. Afterwards, the receiving module 110 receives “server” as the data of “phrase”, “In a local area network, a data station provides all kinds of facilities to other data stations, such as file server, printer server, and mail server” as the data of “explanation”, and “computer” as the data of “attribute”.

Alternatively, the data of the dictionary items can be received by the receiving module 110 in a batch. That is, the customized dictionary generating system 100 allows the user to enter the data according a system predetermined data input rule. So the receiving module 110 imports the data of the dictionary items in a batch.

The setting module 120 establishes individual setting sectors for the dictionary items for defining the formats thereof. It should be noted that the format referred herein defines the information type, language, unit, font, font style, font, size, color, encode, effect, alignment, etc. That is, the format defines the display effect of each dictionary item for the user to view the dictionary item. After the receiving module 110 receives the dictionary items, the setting module 120 establishes one setting sector for each of the dictionary items. The user can thus set the format for each of the dictionary items.

In the above example, the setting module establishes a setting sector for each of the dictionary items “phrase”, “explanation”, and “attribute” received by the receiving module 110. According to the display rules of dictionary fields, the setting module 120 allows the user to set the field formats. For example, the user can set “color: red”, “font size: 14”, “font: BiaoKai” in the format setting sector of the dictionary item “phrase”, “color: black”, “font size: 12”, “font: BiaoKai” in the format setting sector of the dictionary item “explanation”, and “color: green”, “font size: 12”, “font: BiaoKai” in the format setting sector of the dictionary item “attribute”.

The generating module 130 generates a dictionary data file from the dictionary items and the data thereof according to the corresponding correlation definitions. As described above, the dictionary items received by the receiving module 110 are associated with corresponding correlation definitions, which define the data structure of the dictionary items. Therefore, the generating module 130 combines the dictionary items and the data thereof as received by the receiving module 110 and generates a dictionary data file according to the corresponding correlation definitions.

In the above example, the generating module 130 follows the dictionary items “phrase”, “explanation”, and “attribute” and the corresponding correlation definitions “first field”, “second field”, and “third field” to generate a dictionary data file “professional term dictionary data file”, for example. That is, the data of “phrase” are put in the “first field”, the data of “explanation” are put in the “second field”, and the data of “attribute” are put in the “third field”. This forms the dictionary data file “professional term dictionary data file”.

The extracting and generating module 140 extracts the formats of the dictionary items and generates a format configuration file for the dictionary items and the corresponding formats. That is, after the setting module 120 provides the settings of the formats of the dictionary items, the extracting and generating module 140 extracts the format of each of the dictionary items. It then generates a format configuration file for the dictionary items and the format thereof.

In the above example, the extracting and generating module 140 extracts the formats “color: red”, “font size: 14”, “font: BiaoKai” for the dictionary item “phrase”, “color: black”, “font size: 12”, “font: BiaoKai” for the dictionary item “explanation”, and “color: green”, “font size: 12”, “font: BiaoKai” for the dictionary item “attribute”. It then put the formats “color: red”, “font size: 14”, “font: BiaoKai” for the dictionary item “phrase”, “color: black”, “font size: 12”, “font: BiaoKai” for the dictionary item “explanation”, and “color: green”, “font size: 12”, “font: BiaoKai” for the dictionary item “attribute” together and generates a format configuration file, the “professional term format configuration file”.

The output module 150 outputs the dictionary data file and the format configuration file into a dictionary file. That is, the dictionary data file obtained by the generating module 130 and the format configuration file obtained by the extracting and generating module 140 are output to the dictionary file. It is worth mentioning that the dictionary file allows dictionary software to access in a designated directory. The designated directory can be defined by the user or, if the user does not define, a default one predetermined by the system.

In the above example, the output module 150 combines the dictionary data file “professional term dictionary data file” obtained by the generating module 130 and the format configuration file “professional term dictionary format configuration file” obtained by the extracting and generating module 140 into a dictionary file “professional term dictionary file”. The dictionary file “professional term dictionary file” can be accessed by dictionary software in a designated directory.

Through the operation of the customized dictionary generating system, the received dictionary items and the data thereof are combined to generate a dictionary data file according to the correlation definitions. The formats of the dictionary items are then extracted to generate a format configuration file for the dictionary items. Finally, the dictionary data file and the format configuration file are output in a dictionary file. This can solve the problem that few dictionary contents can be displayed when the user builds his own dictionary in the prior art.

In the following an embodiment is used to explicitly explain the disclosed method. However, it is not used to restrict the scope of the invention. Any person skilled in the art can easily modify the embodiment without departing from the spirit of the invention.

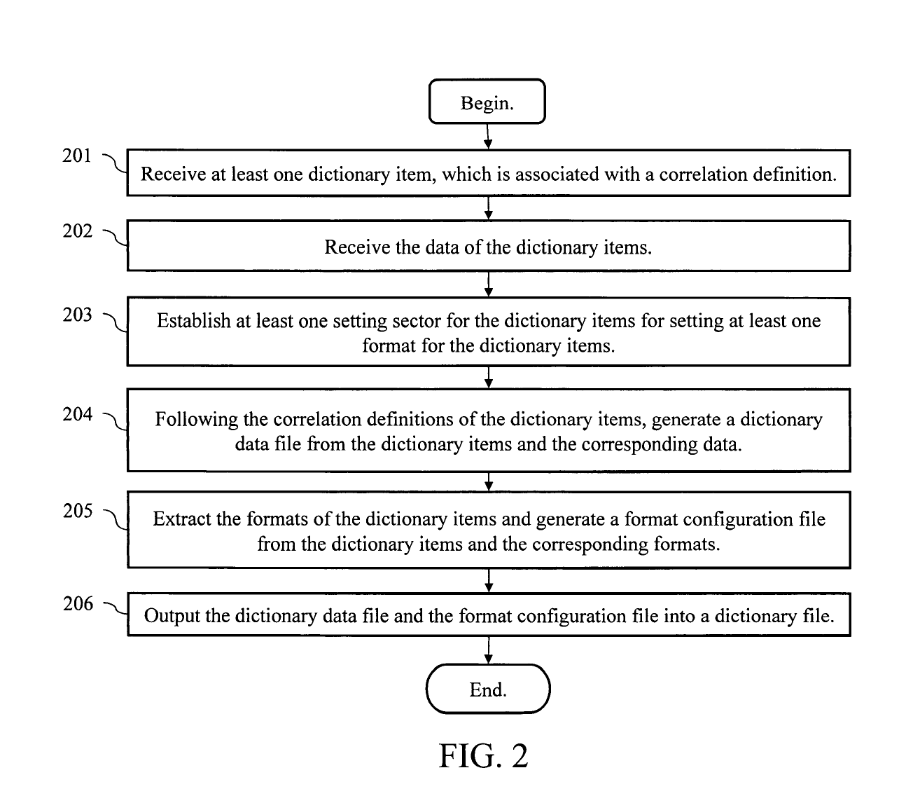

FIG. 2 is a flowchart of the disclosed method of generating a customized dictionary. Please refer to FIGS. 2 to 5 for the operating steps of the disclosed system according to the embodiment. In this embodiment, the user wants to establish a customized computer dictionary.

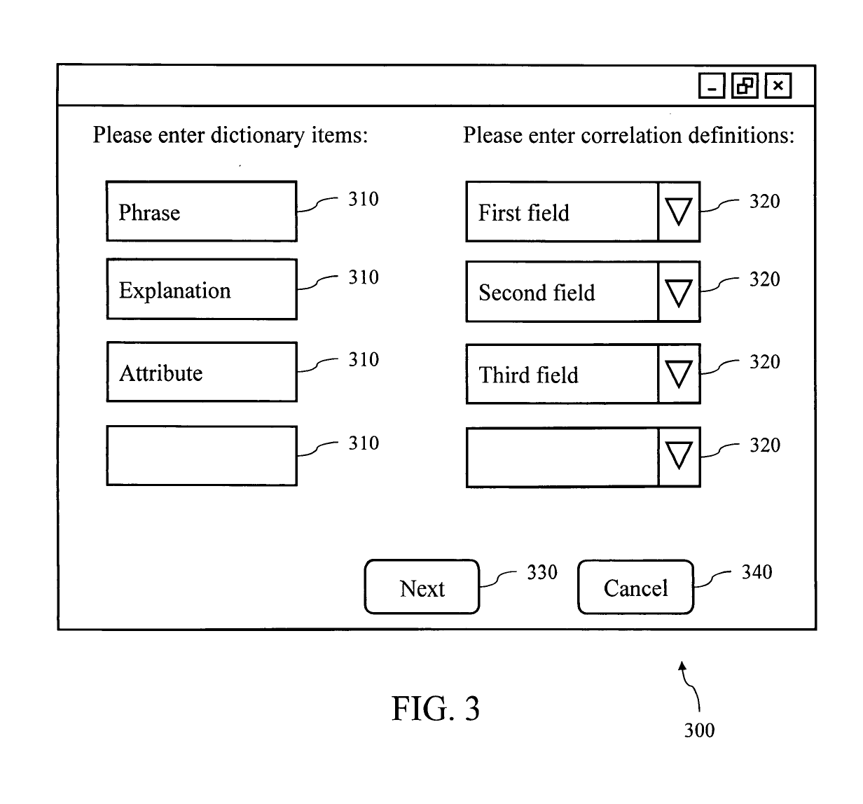

Please first refer to FIG. 3. The dictionary item and correlation definition input interface 300 includes a dictionary item input field 310, a correlation definition input field 320, a Next element 330, and a Cancel element 340. In the dictionary item and correlation definition input interface 300 provided by the customized dictionary generating system 100, the user enters the dictionary items “phrase”, “explanation”, and “attribute” in the dictionary item input field 310 and the correlation definitions “first field”, “second field”, and “third field” corresponding to “phrase”, “explanation”, and “attribute” in the correlation definition input field 320. After the user finishes with the input, he can click the Next element 330. The customized dictionary generating system 100 receives the dictionary items “phrase”, “explanation”, and “attribute” along with the corresponding correlation definitions “first field”, “second field”, and “third field” (step 201). If the user wants to stop using the customized dictionary generating system 100, he can click the Cancel element 340. In this case, the customized dictionary generating system 100 finishes the procedure of generating a dictionary.

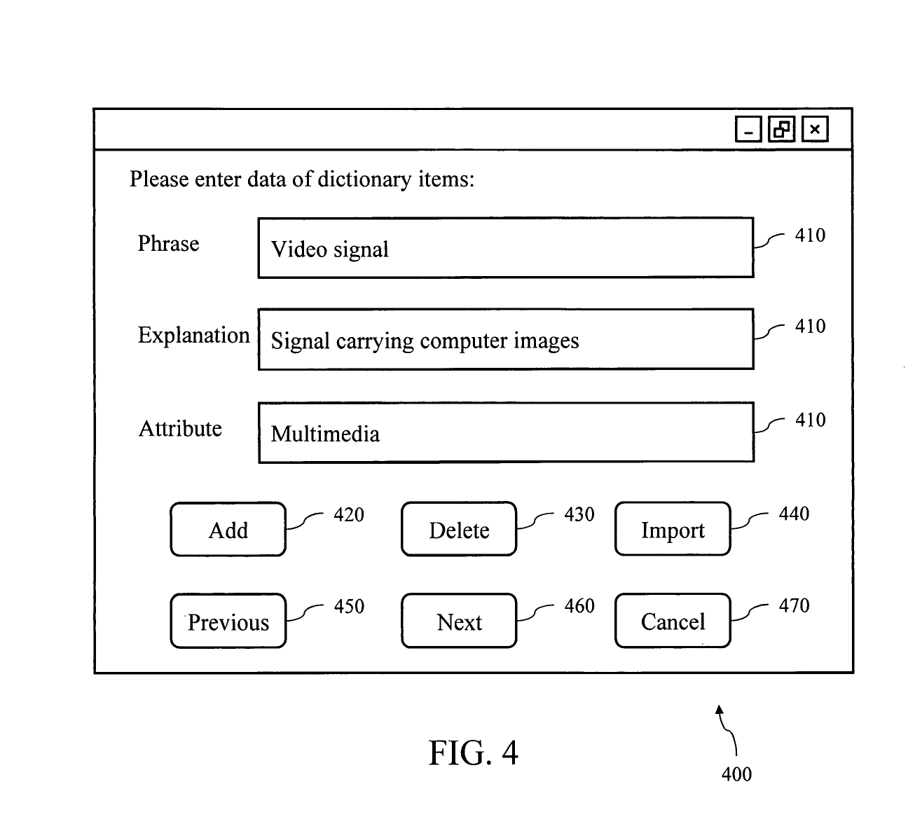

Please refer to FIG. 4. The data input interface 400 for the dictionary items includes a data input field 410, an Add element 420, a Delete element 430, an Import element 440, a Previous element 450, a Next element 460, and a Cancel element 470. In the data input field 410 of the data input interface 400 for the dictionary items of the customized dictionary generating system 100, the user enters the data “video signal” for the dictionary item “phrase”, “signals carrying computer images” for “explanation”, and “multimedia” for “attribute”. After the user finishes the input, he can click the Add element 420. The customized dictionary generating system 100 receives “video signal”, “signals carrying computer images”, and “multimedia” for the “phrase”, “explanation”, and “attribute”, respectively (step 202). After the user enters the data for the dictionary items, he can select the Next element 460. The customized dictionary generating system 100 continues to generate the dictionary. If the user wants to return to the dictionary item and correlation definition input interface 300, he can click the Previous element 450. If the user wants to the quit the customized dictionary generating system 100, he can click the Cancel element 470 and the customized dictionary generating system 100 finishes the dictionary generating procedure. Besides, the Delete element 430 enables the user to delete some dictionary item data. It deletes the data of the dictionary items one by one. The Import element 440 enables the user to enter the data of the dictionary items in a batch.

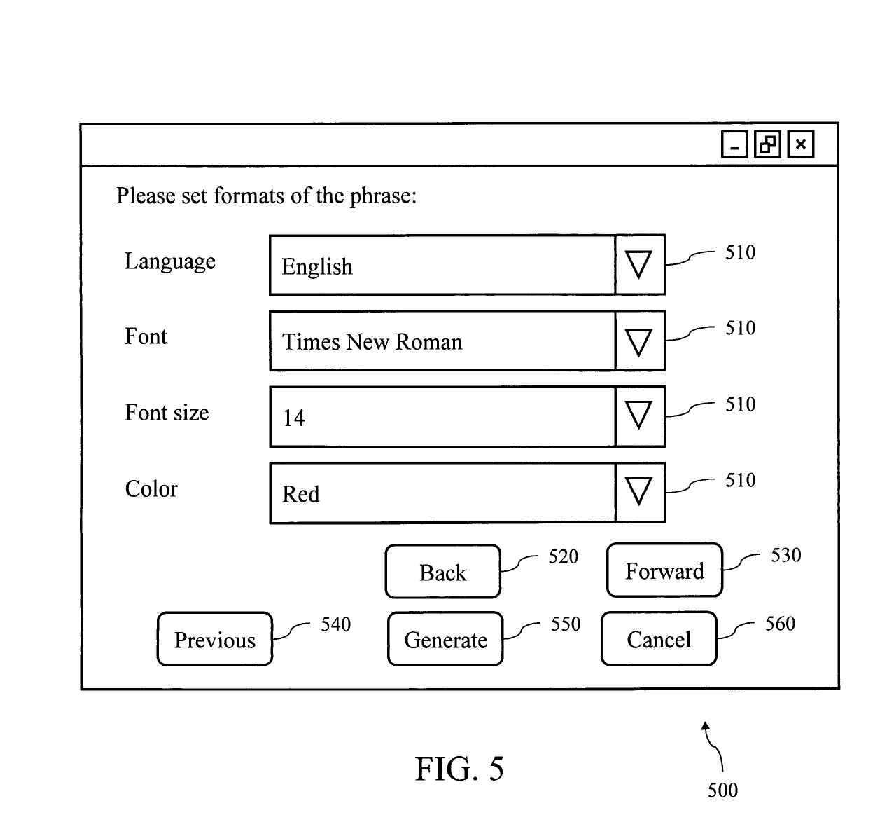

Please refer to FIG. 5. The format setting interface 500 of the dictionary items includes a format setting field 510, a Back element 520, a Forward element 530, a Previous element 540, a Generate element 550, and a Cancel element 560. The customized dictionary generating system 100 follows the dictionary items “phrase”, “explanation”, and “attribute” to establish the respective format setting fields 510 for the user to set their own formats (step 203). Take the format setting of the dictionary item “phrase” as an example. In the format setting field 510 of the format setting interface 500 for the dictionary items provided by the customized dictionary generating system 100, the user sets “language: English”, “font: Times New Roman”, “font size: 14”, and “color: red”. Afterwards, the user can use the Back element 520 and the Forward element 530 to set the formats of the dictionary items “explanation” and “attribute”. After the user finishes setting the formats of the dictionary items one by one, he can click the Generate element 550 and the customized dictionary generating system 100 continues to the step of generating the dictionary. If the user wants to go back to the data input interface 400 for the dictionary items, he can click the Previous element 540. If the user wants to quit the customized dictionary generating system 100, he can click the Cancel element 560 and the customized dictionary generating system 100 finishes the dictionary generating procedure.

After the user clicks the Generate element 550, the customized dictionary generating system 100 follows the correlation definitions “first field”, “second field”, and “third field” for the dictionary items “phrase”, “explanation”, and “attribute” to write the respective data into “computer dictionary data file”, thereby generating the dictionary data file (step 204).

Afterwards, the customized dictionary generating system 100 extracts the formats of the dictionary items “phrase”, “explanation”, and “attribute” set by the user via the format setting interface 500 for the dictionary items. It then combines the dictionary items “phrase”, “explanation”, and “attribute” and the respective formats to generate the format configuration file “computer dictionary format configuration file” (step 205).

Finally, the customized dictionary generating system 100 outputs the dictionary data file “computer dictionary data file” and the format configuration file “computer dictionary format configuration file” into a dictionary file “computer dictionary file” (step 206). The dictionary file “computer dictionary file” allows dictionary software to access according to a directory designated by the user. When the user uses the dictionary file “computer dictionary file” on dictionary software, the formats displayed by the dictionary file “computer dictionary file” are in accord with the user's settings. This achieves the goal of generating a customized dictionary.

In summary, the invention differs from the prior art in that it receives the dictionary items and the data thereof and follows the correlation definition to generate a dictionary data file. It further extracts the formats of individual dictionary items and generates a format configuration file for the dictionary items. Finally, the dictionary data file and the format configuration file are output in a dictionary file. Using the disclosed technique, the invention solves the problem of displaying too little dictionary contents built by the user in the prior art. It allows the user to generate a customized dictionary.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A customized dictionary generating system, comprising:
a receiving module, which receives a plurality of dictionary items and the data thereof, wherein each of the dictionary items is associated with a correlation definition;
a setting module, which establishes at least one setting sector for each of the dictionary items for setting at least one format for each of the dictionary items;
a generating module, which follows the correlation definitions of the dictionary items to generate a dictionary data file from the dictionary items and the corresponding data;
an extracting and generating module, which extracts the formats of the dictionary items and generates a format configuration file from the dictionary items and the corresponding formats; and
an output module, which outputs the dictionary data file and the format configuration file into a dictionary file.

2. The customized dictionary generating system of claim 1, wherein the dictionary file allows dictionary software to access according to a designated directory.

3. The customized dictionary generating system of claim 1, wherein the formats define at least one of the information type, language, scale, font, font style, font size, color, encode, effect, alignment associated with the contents of the dictionary items.

4. The customized dictionary generating system of claim 1, wherein the receiving module receives the data of the dictionary items by providing individual input fields for the input of the data of the dictionary items or by importing the data of the dictionary items in a batch.

5. The customized dictionary generating system of claim 1, wherein the correlation definition defines the data structure of the dictionary items.

6. A customized dictionary generating method, comprising the steps of:
receiving a plurality of dictionary items, each of which is associated with a correlation definition;
receiving the data of the dictionary items;
establishing at least one setting sector for each of the dictionary items for setting the formats thereof;
following the correlation definitions of the dictionary items, generating a dictionary data file from the dictionary items and the corresponding data;
extracting the formats of the dictionary items and generating a format configuration file from the dictionary items and the corresponding formats; and
outputting the dictionary data file and the format configuration file into a dictionary file.

7. The customized dictionary generating method of claim 6, wherein the dictionary file allows dictionary software to access according to a designated directory.

8. The customized dictionary generating method of claim 6, wherein the formats define at least one of the information type, language, scale, font, font style, font size, color, encode, effect, alignment associated with the contents of the dictionary items.

9. The customized dictionary generating method of claim 6, wherein the step of receiving the data of the dictionary items is done by providing individual input fields for the input of the data of the dictionary items or by importing the data of the dictionary items in a batch.

10. The customized dictionary generating method of claim 6, wherein the correlation definition defines the data structure of the dictionary items.
